(19) United States
(12) Patent Application Publication
(10) Pub. No.: US 2004/0245075 A1
(43) Pub. Date: Dec. 9, 2004

(54) Transport system, in particular airport baggage handling system, for transport of containers with articles, in particular bags

(75) Inventors: Wolfgang Brixius, Neunkirchen (DE); Dominik Grafer, Dortmund-Wellinghofen (DE); Albrecht Hoene, Lappersdorf (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/841,953

(22) Filed: May 7, 2004

(30) Foreign Application Priority Data
May 9, 2003 (DE) 103 20 963.8

(51) Int. Cl. B65G 15/60

(52) U.S. Cl. 198/836.2; 198/837

(57) ABSTRACT

A transport system, in particular airport baggage handling system, for transport of containers with articles, in particular bags, includes a discharge unit for unloading a container which supports an article and defines a longitudinal axis. The discharge unit includes a curve section to define a curved transport path, and an engagement assembly for guiding and moving the container at a desired speed. The engagement assembly is constructed to move the container along the curved transport path at a transport speed by which the article is forced outwards as a result of centrifugal forces so that the article spontaneously slides from the container.

### CROSS-REFERENCES TO RELATED APPLICATIONS

This application claims the priority of German Patent Application, Serial No. 103 20 963.8, filed May 9, 2003, pursuant to 35 U.S.C. 119(a)-(d), the disclosure of which is incorporated herein by reference.

### BACKGROUND OF THE INVENTION

The present invention relates, in general, to a transport system, in particular airport baggage handling system, for transport of containers with articles, in particular bags.

European patent publication no. EP 0 806 384 A2 describes a discharge unit of a transport system that can be used as an airport baggage handling system and includes containers for transport of articles, such as bags or suitcases. The discharge unit is constructed to tilt the containers to one side so that the articles slide from the container under the influence of gravity in a discharge zone which has a slide for transfer of the articles. Tilting of the containers is realized by lifting one of two parallel rails of the transport path for moving the containers upwardly to a tilt angle sufficient to allow a sliding of the articles from the container. The angular disposition of the container is maintained until the articles are expelled.

Another approach involves the provision of a discharge unit which includes grippers to grab a container and to swing the container at a predetermined site by about an axis parallel to the transport direction until the container assumes an inclined position. After the container is emptied, the grippers return to their initial position.

Still another approach involves the provision of a discharge unit which tilts the containers about a fixed rotation axis, when the container reaches the discharge unit and is slowed down to speed zero. The container remains immobile at this location until being empty. After emptying, the container is moved back to the original position and moved away from the discharge unit.

It would be desirable and advantageous to provide an improved transport system and improved discharge unit to obviate prior art shortcomings and to allow desired control of an unloading operation to thereby advance the containers at relatively great speed.

### SUMMARY OF THE INVENTION

According to one aspect of the present invention, a transport system, in particular airport baggage handling system, for transport of containers with articles, in particular bags, includes a discharge unit for unloading a container which supports an article and defines a longitudinal axis, wherein the discharge unit includes a curve section to define a curved transport path, and an engagement assembly for guiding and moving the container at a desired speed, with the engagement assembly being constructed to move the container along the curved transport path at a transport speed to so accelerate the article outwards as a result of a centrifugal force that the article spontaneously slides from the container.

The present invention resolves prior art problems by providing a transport system which has two transport speeds for the container transport which lie sufficiently apart to effect an unloading of the containers by simply switching from one speed to the other speed. This can normally be implemented in the absence of any additional parts and drives so that costs can be kept relatively low. Moreover, the increase in speed positively affects the passing rate by which the containers to be unloaded can advance through the transport system.

According to another feature of the present invention, the discharge unit may have support elements for support of an underside of the container. In this way, the engagement assembly can be constructed in a simple manner.

According to another feature of the present invention, the underside of the container may be formed with two touch surfaces extending in transport direction in mirror-symmetric relationship and curved at a radius, which corresponds to a radius of the curve section, such that a distance between the touch surfaces is at a limit in mid-section of the touch surface, wherein the engagement assembly is constructed to bear upon the touch surfaces, at least along portions thereof, by interference fit for propulsion of the container. Hereby, the touch surfaces may be curved outwardly so that the distance between the touch surfaces is at a maximum in mid-section of the touch surface, or the touch surfaces may be curved inwardly so that the distance between the touch surfaces is at a minimum in mid-section of the touch surface. In this way, the change in speed can be realized quickly, while the containers are held and guided by a forced engagement.

According to another feature of the present invention, the touch surfaces may be formed by confronting sidewalls of a groove-shaped passageway provided in the underside of the container as mirror images of one another on both sides of the longitudinal axis. Suitably, the sidewalls of the passageway are outwardly curved mirror-symmetrically at a radius which corresponds to a radius of the curve section, thereby defining a greatest distance between the sidewalls in mid-section of the container. In this way, the containers are guided and accelerated in an optimum manner in the curve section. As an alternative, it is also possible to inwardly curve the sidewalls of the passageway mirror-symmetrically at a radius which corresponds to a radius of the curve section, thereby defining a smallest distance between the sidewalls in mid-section of the container.

In order to attain a substantially silent transport of the containers, the sidewalls of the passageway may have a distance to conform to a width of the engagement assembly in leading and trailing zones of the passageway, as viewed in transport direction, wherein the sidewalls extend steadily outwards to form a funnel-shaped configuration of the passageway in the leading and trailing zones.

According to another feature of the present invention, the sidewalls of the passageway may be positioned as mirror images in inclined relationship to form a configuration of the passageway in downwardly expanding direction.

According to another feature of the present invention, the container has a topside intended for receiving the article and constructed in symmetry to the longitudinal axis in the form of a trough which is curved downwards. Suitably, the topside is parabolic in transverse direction to the longitudinal axis in order to ensure an unloading of the containers.

According to another feature of the present invention, the engagement assembly may include two rows of rollers in the curve section, each of the rows of rollers defined by a surface line extending on a circular path in parallel relationship to at least one of the touch surfaces, whereby a driving belt is wrapped around at least one of the rows of rollers and rests against one of the touch surfaces, while the other one of the rows of rollers is in contacting relationship, at least along areas thereof, with the other one of the touch surfaces. Such construction of the engagement assembly assures a firm gripping and guiding of the containers along the travel path.

As an alternative, the engagement assembly may include cantilevered beveled or cylindrical rollers engaging the passageway and disposed behind one another in the transport direction at least in one row, with each of the rollers bearing at least against one of the sidewalls of the passageway. In order to keep a tilting of the containers in the curve section to a minimum, the rollers may be arranged along a circular path, when the rollers engage the curve section, wherein the circular path is defined by a radius center point which is located on an axis which extends through a center point of the curve section and a radius center point of one of the sidewalls of the passageway.

Guiding and/or propelling of the containers can be enhanced, when constructing the engagement assembly in a curve section of the conveyor in the form of two rows of bevel wheels.

According to another aspect of the present invention, a discharge unit of a transport system, in particular airport baggage handling system, for unloading containers used for transport of articles, includes a curve section to define a curved transport path, and an engagement assembly for guiding and moving the container at a desired speed, wherein the engagement assembly is constructed to move the container along the curved transport path at a transport speed to so accelerate the article outwards as a result of a centrifugal force that the article spontaneously slides from the container.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top perspective view of a portion of a transport system according to the present invention with a discharge unit having a curved transport path realized by two curve sections;

FIG. 2 is a top perspective view of one curve section of FIG. 1 on an enlarged scale;

FIG. 3 is a perspective illustration of the curve section of FIG. 1 with advancing container;

FIG. 4 is a schematic bottom and side perspective view, on an enlarged scale, of another embodiment of a curve section in cooperation with a guiding and/or driving engagement assembly of a container transport system according to the present invention; and

FIG. 5 is a perspective view of still another embodiment of a curve section according to the present invention as kinematic reversal of the curve section of FIG. 4.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

In this context, reference is made to commonly assigned earlier filed U.S. patent applications Ser. No. 10/789,195, filed Feb. 27, 2004, entitled “Container Transport System and Container for Transport of an Article”, and U.S. Ser. No. 10/789,198, filed Feb. 27, 2004, entitled “Transport System for Advancing Containers, and Curve Section of such a Transport System, the disclosure of which is incorporated herein by reference.

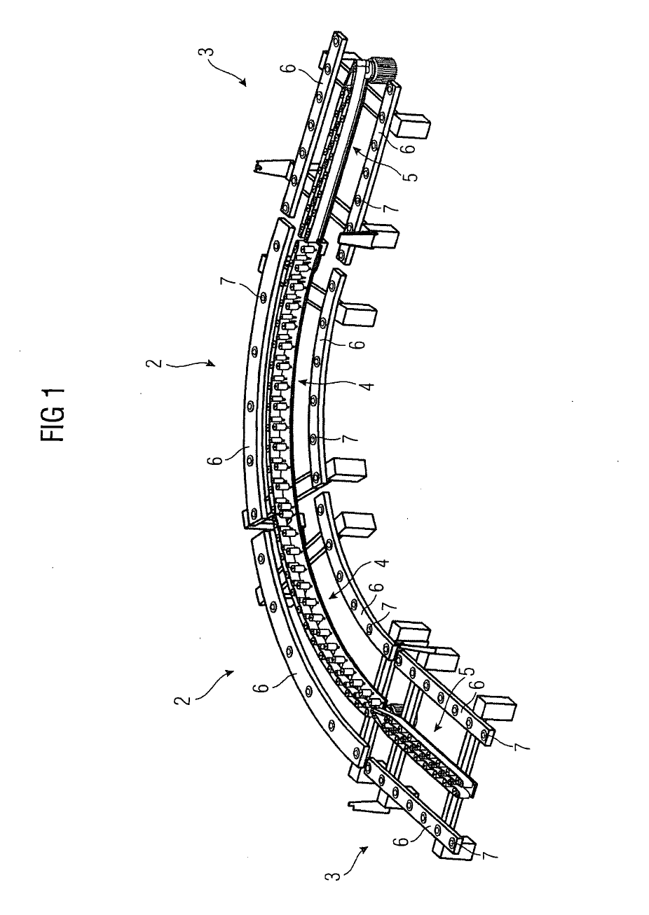

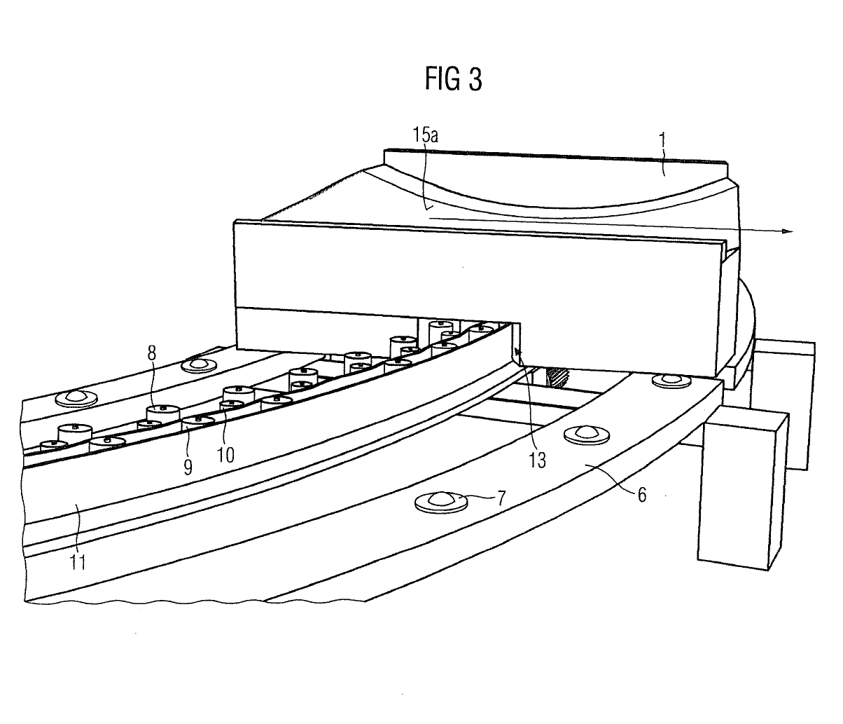

Turning now to the drawing, and in particular to FIG. 1, there is shown a top perspective view of a portion of a transport system according to the present invention for use, for example, as an airport baggage handling system. The transport system includes a discharge unit having a curved track to define a transport path constructed for transport of containers 1, shown in more detail in FIG. 3. The curved track is comprised of two curve sections, generally designated by reference numeral 2. Of course, the curve sections 2 may also be constructed in single-piece configuration. The curve sections 2 are disposed immediately following one another, with a straight conveyor 3 positioned upstream of one curve section 2 and a straight conveyor 3 positioned downstream of the other curve section 2. The straight conveyors 3 are each provided in mid-section with a driving and/or guiding engagement assembly 4 whereas the curve sections 2 are each provided in mid-section with a driving and/or guiding assembly 5. In the following description, assemblies 4 and 5 are each referred to as “engagement assembly”. Disposed on both sides of the engagement assemblies 4, 5 is a support assembly in the form of support plates 6, with the containers 1 being supported with their underside through intervention of ball rollers 7 upon the support plates 6.

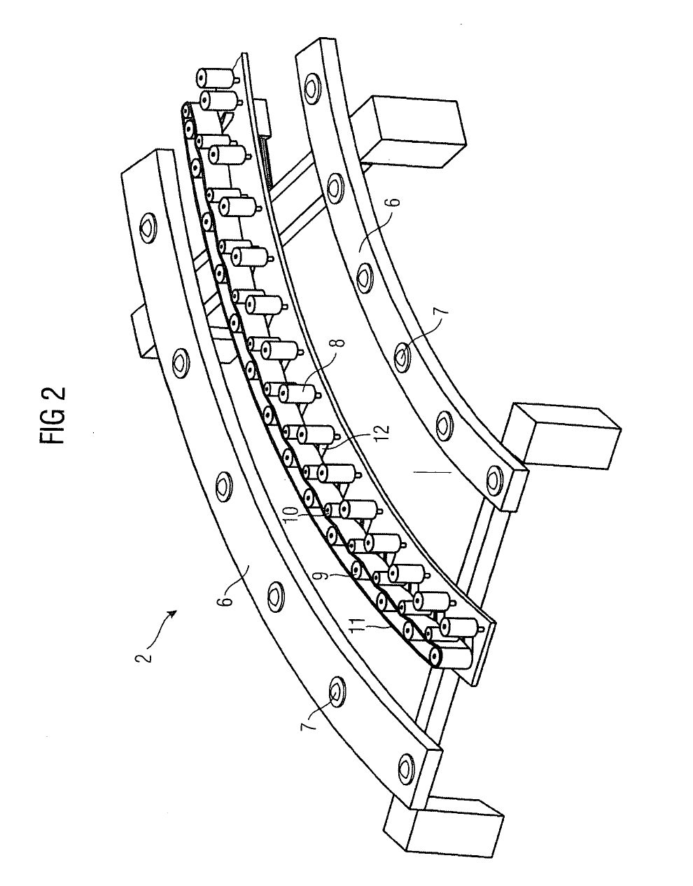

Turning now to FIG. 2, there is shown a top perspective view of one curve section 2 of the discharge unit shown in FIG. 1 on an enlarged scale. The engagement assembly 4 includes three rows of rollers 8, 9, 10, which are disposed in parallel relationship to follow a direction of an imaginary curve line of the curved transport path, and a driving belt 11. The rollers 8 extend hereby on one side of the curve line to constitute inner rollers, and the rollers 9 extend on the other side of the curve line to constitute outer rollers, whereas the rollers 10 are secondary rollers which are placed directly on the curved line between the rollers 8, 9. The rollers 8 are freely rotatably supported while the rollers 9 guide and drive the continuously running driving belt 11. In addition, the outer rollers 9 are each swingably supported on a lever arm 12 which is defined by a pivot axis in parallel relationship to the rotation axis of the associated roller 9 and disposed between the rollers 9 and the inner rollers 8. The secondary rollers 10 are so disposed that the load-bearing strand of the driving belt 11 is moved in a wavy manner along the secondary rollers 10 and thereby pushed outwards so as to brace the container 1 by interference fit between the inner rollers 8 and the outwardly directed outer side of the driving belt 11.

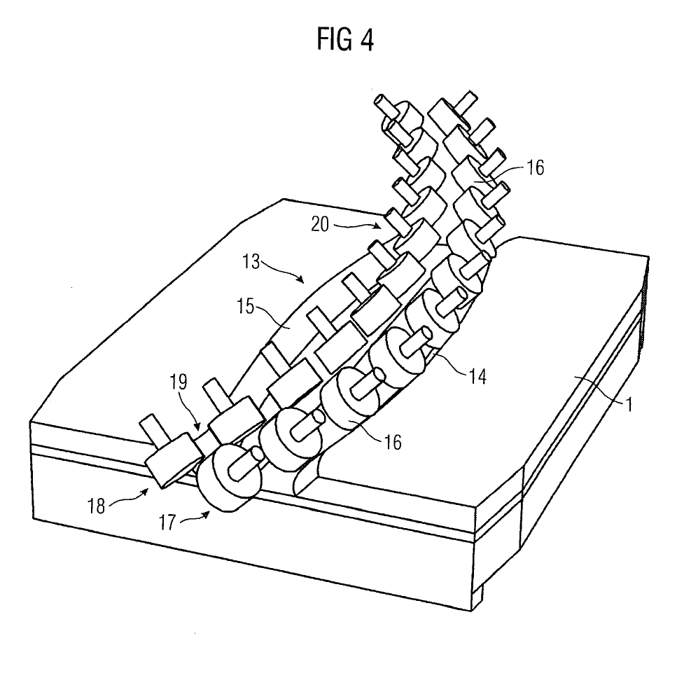

FIG. 3 shows a perspective illustration of the curve section 2 of FIG. 1 with advancing container 1 which has touch surfaces for cooperation with the engagement assemblies 4, 5. The container 1 has hereby a container bottom with an underside which has formed therein a passageway 13 in the form of a groove. The passageway 13 is bounded by sidewalls 14, 15 (FIG. 4) of the touch surfaces in mirror-symmetrical relationship. The sidewalls 14, 15 are outwardly curved in such a manner as to define between the sidewalls 14, 15 a greatest distance approximately in mid-section of the container 1. The engagement assemblies 4, 5 engage the passageway 13 and are forced into engagement against at least some areas of both sidewalls 14, 15 to thereby realize a guided advance of the containers 1. The sidewalls 14, 15 extend in correspondence to the rollers 8, 9 and the driving belt 11 in perpendicular relationship to the bottom underside of the container 1.

As further shown in FIG. 3, the container 1 has a topside 15a with an inwardly (downwardly) arched or trough-shaped surface in symmetry to the longitudinal container axis to receive an article and to hold it securely and stably, as the container 1 is moved by the transport system along curved section 2. The topside 15a may be configured parabolically transversely to the longitudinal container axis.

As the containers 1 reach the discharge unit of the transport system, the transport speed of the discharge unit is accelerated by the engagement assembly 4 in the curve section 2 to such an extent that an article (not shown), placed in the container 1, is moved outwards as a result of centrifugal forces, as indicated by the arrow, and thus expelled spontaneously from the container 1.

FIG. 4 shows a perspective view of another embodiment of the curve section 2 for a container 1. In this embodiment, the sidewalls 14, 15 of the container 1 extend slantingly in relation to one another in such a manner that the groove-shaped passageway 13 opens up to the outside. The engagement assembly 5 of the curve section 2 is here realized by bevel rollers 16 disposed in two parallel roller tracks 17, 18. In the curved zone of the curve section 2, the roller tracks 17, 18 bear against the sidewalls 14, 15 in such a manner that the roller track 17 bears almost completely against the sidewall 14 whereas the roller track 18 bears only against short sidewall sections 19, 20.

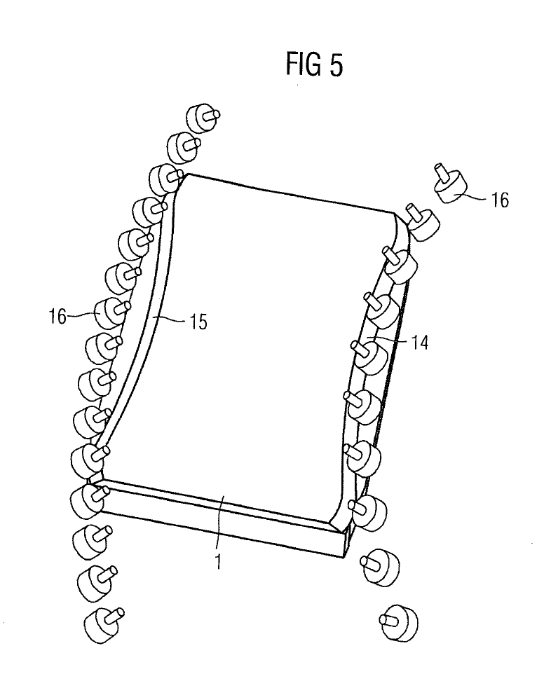

Referring now to FIG. 5, there is shown a kinematic reversal of the of the curve section 2 of FIG. 4. Parts corresponding with those in FIG. 4 are denoted by identical reference numerals and not explained again. The description below will center on the differences between the embodiments. The sidewalls 14, 15 for guiding and propelling the container 1 are arranged on both sides of the container 1 in symmetric relationship. Depending on which of the bevel rollers 16 assume the propulsion during travel in the curved section 2, the sidewalls 14, 15 may be curved convexly (not shown) or, as shown in FIG. 5, may be curved concavely, so that the bevel rollers 16 bear upon the container 1 in the inner side or outer side of the curve section 2 of the container 1.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A transport system, in particular airport baggage handling system, for transport of containers with articles, in particular bags, comprising a discharge unit for unloading a container which supports an article and defines a longitudinal axis, said discharge unit including a curve section to define a curved transport path, and an engagement assembly for guiding and moving the container at a desired speed, said engagement assembly being constructed to move the container along the curved transport path at a transport speed to so accelerate the article outwards as a result of a centrifugal force that the article spontaneously slides from the container.

2. The transport system of claim 1, wherein the discharge unit has support elements for support of an underside of the container.

3. The transport system of claim 1, wherein the container has an underside formed with two touch surfaces extending in transport direction in mirror-symmetric relationship and curved at a radius, which corresponds to a radius of the curve section, such that a distance between the touch surfaces is at a limit in mid-section of the touch surface, said engagement assembly constructed to bear upon the touch surfaces, at least along portions thereof, by interference fit for propulsion of the container.

4. The transport system of claim 3, wherein the touch surfaces are curved outwardly so that the distance between the touch surfaces is at a maximum in mid-section of the touch surface.

5. The transport system of claim 3, wherein the touch surfaces are curved inwardly so that the distance between the touch surfaces is at a minimum in mid-section of the touch surface.

6. The transport system of claim 3, wherein the touch surfaces are formed by confronting sidewalls of a groove-shaped passageway provided in the underside of the container as mirror images of one another on both sides of the longitudinal axis.

7. The transport system of claim 6, wherein the sidewalls of the passageway are outwardly curved mirror-symmetrically at a radius which corresponds to a radius of the curve section, thereby defining a greatest distance between the sidewalls in mid-section of the container.

8. The transport system of claim 6, wherein the sidewalls of the passageway are inwardly curved mirror-symmetrically at a radius which corresponds to a radius of the curve section, thereby defining a smallest distance between the sidewalls in mid-section of the container.

9. The transport system of claim 6, wherein the sidewalls of the passageway have a distance from one another to conform to a width of the engagement assembly in leading and trailing zones of the passageway, as viewed in transport direction, wherein the sidewalls extend steadily outwards to form a funnel-shaped configuration of the passageway in the leading and trailing zones.

10. The transport system of claim 6, wherein the sidewalls of the passageway are positioned as mirror images in inclined relationship to form a configuration of the passageway in downwardly expanding direction.

11. The transport system of claim 1, wherein the container has a topside intended for receiving the article and constructed in symmetry to the longitudinal axis in the form of a trough which is curved downwards.

12. The transport system of claim 11, wherein the topside is parabolic in transverse direction to the longitudinal axis.

13. The transport system of claim 3, wherein the engagement assembly includes two rows of rollers in the curve section, each of the rows of rollers defined by a surface line extending on a circular path in parallel relationship to at least one of the touch surfaces, and further comprising a driving belt wrapped around at least one of the rows of rollers and resting against one of the touch surfaces, while the other one of the rows of rollers is in contacting relationship, at least along areas thereof, with the other one of the touch surfaces.

14. The transport system of claim 6, wherein the engagement assembly includes cantilevered beveled or cylindrical rollers engaging the passageway and disposed behind one another in the transport direction at least in one row, with each of the rollers bearing at least against one of the sidewalls of the passageway.

15. The transport system of claim 14, wherein the rollers are arranged along a circular path, when the rollers engage the curve section, wherein the circular path is defined by a radius center point which is located on an axis which extends through a center point of the curve section and a radius center point of one of the sidewalls of the passageway.

16. A discharge unit of a transport system, in particular airport baggage handling system, for unloading containers used for transport of articles, comprising:
a curve section to define a curved transport path; and
an engagement assembly for guiding and moving the container at a desired speed, said engagement assembly being constructed to move the container along the curved transport path at a transport speed to so accelerate the article outwards as a result of a centrifugal force that the article spontaneously slides from the container.
